(19) United States
(12) Patent Application Publication
(10) Pub. No.: US 2018/0182351 A1
(43) Pub. Date: Jun. 28, 2018

(54) DISPLAY METHOD AND DISPLAY DEVICE USING THE SAME

(71) Applicants: BenQ CO., LTD., Shanghai (CN); BENQ CORPORATION, Taipei (TW)

(72) Inventor: Hsin-Nan Lin, New Taipei City (TW)

(73) Assignees: BenQ CO., LTD., Shanghai (CN); BENQ CORPORATION, Taipei (TW)

(21) Appl. No.: 15/846,298

(22) Filed: Dec. 19, 2017

(30) Foreign Application Priority Data
Dec. 22, 2016 (CN) 201611199222.6

(51) Int. Cl. G09G 5/02; G09G 5/36

(52) U.S. Cl. CPC G09G 5/02; G09G 2360/144; G09G 2320/0666; G09G 5/363

(57) ABSTRACT

A display method and a display device using the same are provided. The display method includes following steps. Firstly, an initial color temperature of a display is set. Then, the display displays a display image at an initial color temperature. Then, a time period at which the display image is continuously displayed at the initial color temperature is detected. Then, when the time period has reached a predetermined time, the display displays the display image at a first color temperature different from the initial color temperature.

This application claims the benefit of People's Republic of China application Serial No. 201611199222.6, filed on Dec. 22, 2016, the subject matter of which is incorporated herein by reference.

### BACKGROUND OF THE INVENTION

### Field of the Invention

The invention relates in general to a display method and a display device using the same, and more particularly to a display method capable of adjusting color temperature according to ambient brightness and a display device using the same.

### Description of the Related Art

Conventional display is used for displaying a display image to provide visual information to the user. However, the user will have eye fatigue after viewing the display image of the display over a long period of time. Therefore, how to design a display device capable of reducing the viewer's eye fatigue has become a prominent task for anyone ordinarily skilled in the technology field of the invention.

### SUMMARY OF THE INVENTION

The invention is directed to a display method and a display device using the same capable of resolving the generally-known problem disclosed above.

According to one embodiment of the invention, a display method for adjusting a color temperature of a display is provided. The display method includes a following steps: setting an initial color temperature of the display; displaying a display image by the display at the initial color temperature; detecting a time period at which the display image is displayed at the initial color temperature continuously; and displaying the display image by the display at a first color temperature when the time period has reached a first predetermined time period, wherein the first color temperature is different from the initial color temperature.

According to another embodiment of the invention, a display device is provided. The display device includes a display and a controller. The display is used for displaying a display image. The controller is operated for: setting an initial color temperature; controlling the display to display the display image at the initial color temperature; detecting a time period at which the display image is displayed at the initial color temperature continuously; and controlling the display to display the display image at a first color temperature when the time period has reached a first predetermined time period, wherein the first color temperature is different from the initial color temperature.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a functional block diagram of a display device according to an embodiment of the invention.

FIG. 2 is a flowchart of a display method of the display device of FIG. 1.

FIG. 3 is a schematic diagram of an adjustment curve of display color temperature according to an embodiment of the invention.

FIG. 4 is a flowchart of a display method of a display device according to another embodiment of the invention.

FIG. 5 is a control diagram of the color temperature of a display image according to another embodiment of the invention.

FIG. 6 is a control diagram of the color temperature of a display image according to another embodiment of the invention.

FIG. 7 is a control diagram of the color temperature of a display image according to another embodiment of the invention.

### DETAILED DESCRIPTION OF THE INVENTION

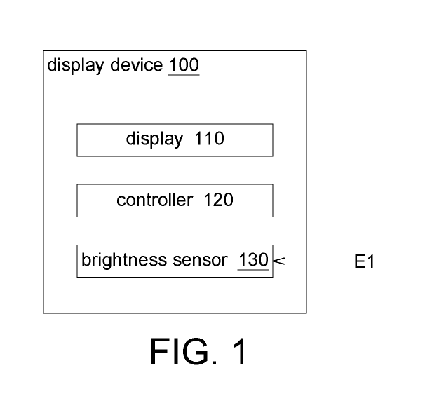

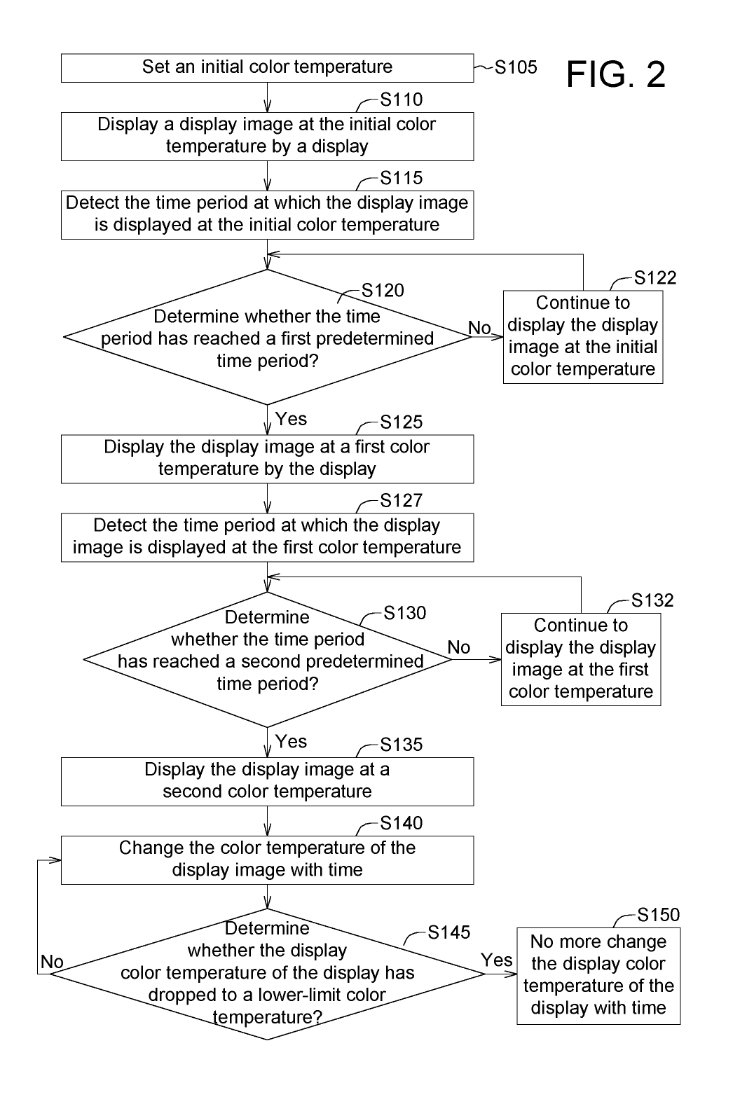

Refer to FIGS. 1 and 2. FIG. 1 is a functional block diagram of a display device 100 according to an embodiment of the invention. FIG. 2 is a flowchart of a display method of the display device of FIG. 1.

As indicated in FIG. 1, the display device 100 includes a display 110, a controller 120 and a brightness sensor 130. The controller 120 can control the color temperature of a display image of the display 110 according to an ambient brightness E1 detected by the brightness sensor 130. Detailed descriptions are disclosed below with accompanying drawing FIG. 2.

In step S105 as indicated in FIG. 2, the controller 120 sets an initial color temperature T0. In an embodiment, the controller 120 can set the initial color temperature T0 according to the user's input. In another embodiment, the controller 120 sets the initial color temperature T0 according to the ambient brightness E1 detected by the brightness sensor 130. For example, when the power of the display 110 is turned on, the controller 120 can set the color temperature of the ambient brightness E1 as the initial color temperature T0.

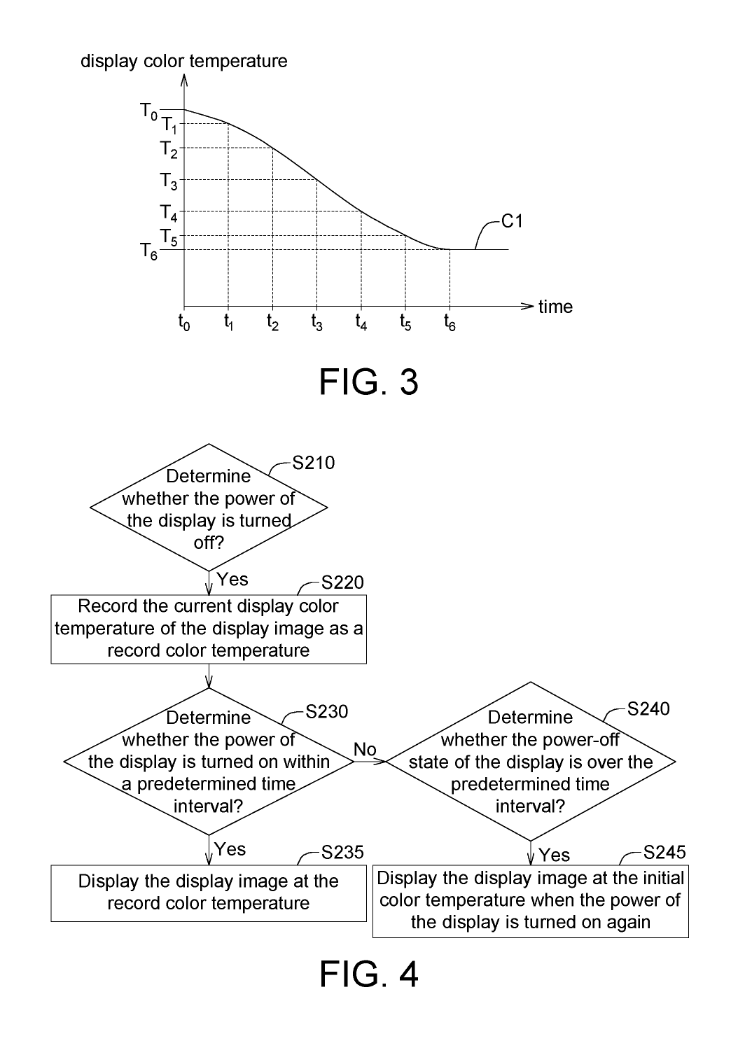

In step S110 as indicated FIG. 3, a schematic diagram of an adjustment curve C1 of display color temperature according to an embodiment of the invention, the controller 120 controls the display 110 to display the display image at the initial color temperature T0. For example, at time point t₀, the display image is displayed at the initial color temperature T0. The time point t₀ can be the time point at which the display 110 switches to a power-on state from a power-off state.

In step S115, the controller 120 detects the time period at which the display image is continuously displayed at the initial color temperature T0. For example, the controller 120 has a timer (not illustrated) disposed therein. Based on the information provided by the timer, the controller 120 can record the time interval within which the display 110 displays the display image at the same color temperature, the time point at which the display 110 switches to a different display color temperature, the power-off time point and time interval of the display 110, and the power-on time point and time interval of the display 110.

In step S120, the controller 120 determines whether the time period has reached a first predetermined time period, such as time point t₀ to time point t₁. If yes, the method proceeds to step S122, the display 110 continues to display the display image at the initial color temperature T0; otherwise, the method proceeds to step S125.

In step S125, the controller 120 controls the display 110 to display the display image at a first color temperature T1 different from the initial color temperature T0. For example, the first color temperature T1 is lower than the initial color temperature T0. It can be understood from the present step: the display color temperature of the display 110 of the present embodiment can decrease with time to reduce the user's eye fatigue resulting from viewing the display image of the display 110 over a long period of time.

In step S127, the controller 120 detects the time period at which the display image is continuously displayed at the first color temperature T1.

In step S130, the controller 120 determines whether the time has reached a second predetermined time period, such as time point t₁ to time point t₂. If yes, the method proceeds to step S132, the controller 120 controls the display 110 to continue to display the display image at the first color temperature T1; otherwise, the method proceeds to step S135.

In step S135, the controller 120 controls the display 110 to display the display image at a second color temperature T2 different from the first color temperature T1. For example, the second color temperature T2 is lower than the first color temperature T1. It can be understood from the present step: the display color temperature of the display 110 of the present embodiment can decrease with time to reduce the user's eye fatigue resulting from viewing the display image of the display 110 over a long period of time.

In step S140, the controller 120 controls the display 110 to change the color temperature of the display image with time. Like steps S130, S132 and S135, after a time interval, the color temperature at which the display 110 displays the display image continues to decrease. As indicated in FIG. 3, at time point t₃, the controller 120 controls the display 110 to display the display image at a third color temperature T3 lower than the second color temperature T2; at time point t₄, the controller 120 controls the display 110 to display the display image at a fourth color temperature T4 lower than the third color temperature T3; at time point t₅, the controller 120 controls the display 110 to display the display image at a fifth color temperature T5 lower than the fourth color temperature T4; and the rest can be obtained by the same analogy.

In step S145, the controller 120 determines whether the display color temperature of the display 110 has dropped to a lower-limit color temperature. For example, if the display color temperature of the display 110 has dropped to a lower-limit color temperature T6 at time point t₆, the method proceeds to step S150. If the display color temperature of the display 110 has not dropped to the lower-limit color temperature, then the method returns to step S140, the controller 120 continues to control the display 110 to change the display color temperature with time.

In step S150, the controller 120 controls the display color temperature of the display 110 to no more change with time. As indicated in FIG. 3, after time point t₆, the controller 120 controls the display color temperature of the display 110 to maintain at the lower-limit color temperature T6 and no more decrease or adjust.

As disclosed above, the controller 120 can control the display 110 to change (increase or decrease) the color temperature of the display image with time according to the ambient brightness E1 detected by the brightness sensor 130. In another embodiment, the color temperature of the display image of the display 110 may alternately increase and decrease. For example, the display color temperature of the display 110 may decrease (or increase) at a time point but increase (or decrease) at a subsequent time point. In other words, the adjustment curve C1 of display color temperature of the invention is not limited to the non-linear decreasing trend as indicated in FIG. 3, and can have a non-linear increasing trend, a linear decreasing trend, a linear increasing trend, or a rise and fall trend. Besides, the adjustment curve C1 of display color temperature can be a continuous curve (such as a smooth curve or a non-smooth curve) or a discontinuous curve with stepped change. The trend of the adjustment curve C1 of display color temperature depends on actual application, and is not subjected to specific restrictions.

FIG. 4 is a flowchart of a display method of a display device 100 according to another embodiment of the invention.

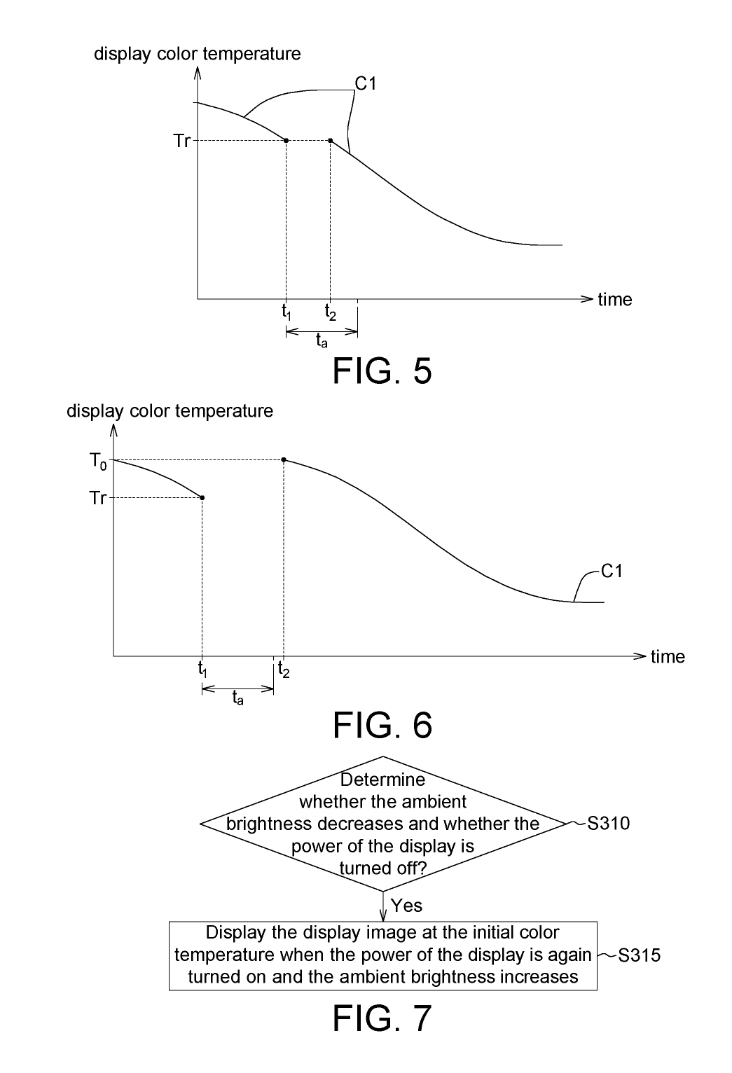

In step S210 as indicated in FIG. 5, a control diagram of the color temperature of a display image according to another embodiment of the invention, the controller 120 determines whether the power of the display 110 is turned off. If the power of the display 110 is turned off, the method proceeds to step S220. As indicated in FIG. 5, at time point t₁, the controller 120 detects that the power of the display 110 is turned off, and the method proceeds to step S220.

In step S220, the controller 120 records the current display color temperature of the display image as a record color temperature. As indicated in FIG. 5, the controller 120 records the current display color temperature of the display image Tr at time point t₁ as a record color temperature.

In step S230, the controller 120 determines whether the power of the display 110 is turned on within a predetermined time interval ta. If yes, the method proceeds to step S235; otherwise, the method proceeds to step S240.

In step S235 as indicated in FIG. 5, the controller 120 controls the display 110 to display the display image at the record color temperature (that is, the display color temperature Tr). In other words, if the power-off state of the display 110 (the display image is turned off) does not last for a predetermined time interval ta, the controller 120 controls the display 110 to display the display image at the display color temperature Tr corresponding to the power-off state of the display 110 when the power of the display 110 is again turned on, such as at the time point t₂ of FIG. 5. However, if the power-off state of the display 110 (the display image is turned off) is over the predetermined time interval ta, the method proceeds to step S240.

In step S240 as indicated in FIG. 6, a control diagram of the color temperature of a display image according to another embodiment of the invention, the controller 120 determines whether the power-off state of the display 110 (the display image is turned off) is over the predetermined time interval ta. If yes, the method proceeds to step S245; otherwise, the method returns to step S230.

In step S245, since the power-off state of the display 110 (the display image is turned off) is over the predetermined time interval ta, the controller 120 controls the display 110 to display the display image at the initial color temperature T0 when the power of the display 110 is turned on again, such as at the time point t₂ of FIG. 6. In other words, if the power-off state is over the predetermined time interval ta, the controller 120 controls the display 110 to return to the step S110 of FIG. 1 when the power of the display 110 is again turned on.

Moreover, the step S210 of FIG. 4 can be performed immediately after anyone step between the steps S105 and S150 of FIG. 2 or immediately after the step S150 of FIG. 2. In other words, in the flowchart of FIG. 2, if the controller 120 detects that the power of the display 110 is turned off, then the method proceeds to the step S220 of FIG. 4.

The adjustment of the display color temperature disclosed in above embodiments is irrelevant to the change in ambient color temperature. In another embodiment, the controller 120 can control the display color temperature of the display 110 according to whether the ambient brightness decreases.

Referring to FIG. 7, a control diagram of the color temperature of a display image according to another embodiment of the invention is shown. In step S310, the controller 120 determines whether the ambient brightness decreases and whether the power of the display 110 is turned off. If yes, the method proceeds to step S315. In step S315, the controller 120 controls the display 110 to display the display image at the initial color temperature T0 when the power of the display 110 is again turned on and the ambient brightness increases.

Let FIG. 5 be taken for example. At time point t₁, if the power of the display 110 is turned off and the ambient brightness already decreases (for example, the light is turned off) or the ambient brightness decreases after a predetermined time interval (for example, the user firstly turns off the display 110 and then decreases the ambient brightness), the controller 120 controls the display 110 to display the display image at the initial color temperature T0 when the power of the display 110 is again turned on and the ambient brightness already increases (for example, the light is turned on) or the ambient brightness increases after a predetermined time interval (for example, the user firstly increases the ambient brightness and then turns on the power of the display 110). In other words, if the ambient brightness decreases and the display image of the display 110 is turned off, this implies that the user may no more need to use the display device 100, and the display 110 again displays the display image at the initial color temperature T0 when the power of the display 110 is turned on next time.

As disclosed above, the controller of the display device according to an embodiment of the invention can control the display to adjust (increase or decrease) the color temperature of the display image with time. Suppose the color temperature decreases. When the power of the display is turned on, the display image can be displayed at a higher color temperature (cooler) according to the ambient brightness or the user's setting, so that the display color temperature can gradually decrease with time, and the user can be gradually adapted to the display image displayed at a lower color temperature (warmer, milder).

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display method for adjusting a color temperature of a display, comprising:
setting an initial color temperature of the display;
displaying a display image by the display at the initial color temperature;
detecting a time period at which the display displays the display image at the initial color temperature continuously; and
displaying the display image by the display at a first color temperature when the time period has reached a first predetermined time period, wherein the first color temperature is different from the initial color temperature.

2. The display method according to claim 1, wherein the step of setting the initial color temperature comprises:
detecting an ambient brightness; and
setting the initial color temperature according to the ambient brightness.

3. The display method according to claim 1, wherein the first color temperature is lower than the initial color temperature.

4. The display method according to claim 3, further comprising:
displaying the display image by the display at a second color temperature when the time period has reached a second predetermined time period;
wherein the second predetermined time period is later than the first predetermined time period, and the second color temperature is lower than the first color temperature.

5. The display method according to claim 1, further comprising:
recording the display color temperature of the display image as a record color temperature if power of the display is turned off; and
displaying the display image at the record color temperature when the power of the display is turned on within a predetermined time interval.

6. The display method according to claim 1, further comprising:
displaying the display image at the initial color temperature when power of the display is again turned on if the power-off state of the display is over a predetermined time interval.

7. The display method according to claim 1, further comprising:
displaying the display image at the initial color temperature when power of the display is again turned on and the ambient brightness increases if an ambient brightness decreases and the power of the display is turned off.

8. The display method according to claim 3, further comprising:
determining whether the display color temperature of the display image has dropped to a lower-limit color temperature; and
no more adjusting the display color temperature of the display image with time if the display color temperature of the display image has dropped to the lower-limit color temperature.

9. A display device, comprising:
a display used for displaying a display image; and
a controller operated for:
setting an initial color temperature;
controlling the display to display the display image at the initial color temperature;
detecting a time period at which the display displays the display image at the initial color temperature continuously; and
controlling the display to display the display image at a first color temperature when the time period has reached a first predetermined time period, wherein the first color temperature is different from the initial color temperature.

10. The display device according to claim 9, wherein the first color temperature is lower than the initial color temperature.

11. The display device according to claim 9, further comprising:
a brightness sensor used for detecting an ambient brightness;
wherein the controller is operated for:
setting the initial color temperature according to the ambient brightness.

12. The display device according to claim 10, wherein the controller is operated for:
controlling the display to display the display image at a second color temperature when the time period has reached a second predetermined time period;
wherein the second predetermined time period is later than the first predetermined time period, and the second color temperature is lower than the first color temperature.

13. The display device according to claim 9, wherein the controller is operated for:
recording the display color temperature of the display image as a record color temperature if the power of the display is turned off; and
controlling the display at the record color temperature to display the display image when the power of the display is turned on within a predetermined time interval.

14. The display device according to claim 9, wherein the controller is operated for:
controlling the display to display the display image at the initial color temperature when the power of the display is turned on again if the power-off time of the display is over a predetermined time interval.

15. The display device according to claim 9, wherein the controller is operated for:
controlling the display to display the display image at the initial color temperature when the power of the display is again turned on and the ambient brightness increases if an ambient brightness decreases and the power of the display is turned off.

16. The display device according to claim 10, wherein the controller is operated for:
determining whether the display color temperature of the display image has dropped to a lower-limit color temperature; and
controlling the display color temperature of the display image not to adjust with time if the display color temperature of the display image has dropped to the lower-limit color temperature.
